(19) United States
(12) Patent Application Publication
(10) Pub. No.: US 2006/0090513 A1
(43) Pub. Date: May 4, 2006

(54) Control for an IS machine

(76) Inventor: Jonathan S. Simon, Pleasant Valley, CT (US)

Correspondence Address: Spencer T. Smith;Emhart Glass Research Inc., 89 Phoenix Avenue, P.O. Box 1229, Enfield, CT, 06083-1229, US

(21) Appl. No.: 10/980,400

(22) Filed: Nov. 3, 2004

(51) Int. Cl. C03B 9/41

(52) U.S. Cl. 65/158; 65/29.11

(57) ABSTRACT

A control for a glass forming machine which includes a blank station for forming a parison from a gob of molten glass having a number of mechanisms, a blow station for forming a parison into a bottle, having a number of mechanisms, a feeder system including a shear mechanism for delivering a gob to the blank station, a mechanism for transferring a parison from the blank station to the blow station and a takeout mechanism for removing a bottle from the blank station. The machine has a set cycle time. Each of the mechanisms in the glass forming machine is cycled within the time of one machine cycle. Interferences exist between the motion paths of the gob, the parison, the bottle and individual mechanisms. The thermal forming of the parison and bottle involve a number of thermal forming processes occurring during the time of one machine cycle and having finite durations. Process air is supplied for at least one process for a finite duration by turning a supply valve “on” and then “off” during the time of one machine cycle. The start of displacement of the mechanisms and the turning of the valves “on” and then “off” are events which are started according to a selected schedule at defined event times within a 360 degree machine cycle. An unwrapped bottle forming process wherein a gob of molten glass is sheared from a runner of molten glass, the gob is then formed into a parison in the blank station, the parison is then formed into a bottle in the blow station, and the bottle is then removed from the blow station, takes more than the time of one machine cycle to complete, comprising a computer analysis means for analyzing the computerized model having at least one constraint as a constrained optimization problem for determining, for at least one section, with target limits on at least one event a target optimized schedule of events to occur within a corresponding target cycle time and for creating and sequentially applying a plurality of sequential intermediate schedule of events and a target schedule of events.

The present invention relates to an I.S. (individual section) machine and more specifically to a control for such a machine.

### BACKGROUND OF THE INVENTION

The first I.S. machine was patented in U.S. Pat. No. 1,843,159, dated Feb. 2, 1932, and in U.S. Pat. No. 1,911,119 dated May 23, 1933. An I.S. (individual section) machine has a plurality of identical sections. Each section has a frame on which are mounted a number of section mechanisms including blank side and blow side mold open and close mechanisms, an invert and neck ring mechanism, a baffle mechanism, a blowhead mechanism, a plunger mechanism and a takeout mechanism. Associated with these mechanisms is process air used for cooling, for example. Each of the section mechanisms and the process air has to be operated at a selected time in the section cycle.

In the original I.S. machine, devices (valves which operated the mechanisms and the process air, for example) had to be mechanically turned on and off each cycle and the timing process was controlled by a 360.degree. timing drum which was a cylindrical drum having a number of annular grooves, one for each valve, each supporting “on” and “off” dogs for tripping a corresponding switch associated with a particular valve. The rotation of this mechanical timing drum through 360.degree has always been equated to the completion of one control cycle of the machine or section and accordingly men skilled in this art have always analyzed machine performance in a wrapped cycle, i.e., one that repeatedly cycles from 0 degrees to 360 degrees. When electronic timing replaced the mechanical timing drum, devices were turned on and off by an electronic sequencer which replicated the wrapped 360 degree control cycle of the mechanical timing drum. An encoder defined the angular location of the electronic sequencer, and electronic switches were turned on and off at the same angles as was the case with a mechanical timing drum.

A significant development that greatly enhanced the power of the electronic sequencer was the concept of thermodynamic modes (U.S. Pat. No. 3,877,915) wherein groups of these electronic switches were linked so that they could be simultaneously adjusted. These machine controllers allow the user to electronically adjust the on/off schedule (event angle(s)) for the various valves, which operate the section mechanisms. This conventional approach does not allow an operator to directly command the machine to achieve desired forming durations (e.g. blank contact time, reheat time). It also does not prevent the user from setting invalid or even potentially damaging sequences in which the mechanisms collide. Only with considerable experience, and process insight can an operator effectively adjust the machine timing with the conventional approach and since skill levels vary greatly, the productivity of the machine can vary substantially.

Another significant development that greatly enhanced the operators ability to set up the machine is a control for the IS machine disclosed in U.S. Pat. No. 6,604,383, U.S. Pat. No. 6,604,384, U.S. Pat. No. 6,604,385, U.S. Pat. No. 6,604,386, and U.S. Pat. No. 6,606,886. This control allows the user to directly set the desired objectives of forming time and cycle duration, and automatically generate a collision free schedule on a machine in which the mechanism motion profiles are controlled by servo controls. This system allows the operator to focus on making better bottles, at higher production rates, and leave the details of scheduling the machine to the software. This approach, however, did not provide for a method to calculate and to apply optimal timings to a machine that had at least on mechanism that is not position controlled.

### OBJECT OF THE INVENTION

It is an object of the present invention to provide an improved control system for a glass forming machine containing at least on mechanism that is not servo position controlled. which will simplify machine operation and facilitate the tuning of the machine for higher productivity and by calculating and applying optimally calculated schedules of events to change the setting of the machine form an initial schedule of events to a target schedule of events. Other objects and advantages of the present invention will become apparent from the following portion of this specification and from the accompanying drawings, which illustrate a presently preferred embodiment incorporating the principles of the invention.

### BRIEF DESCRIPTION OF THE DRAWINGS

FIG. 1 is a schematic illustration of one section of an I.S. machine, which can have one or more of such sections,

FIG. 2 is a flowchart providing a high level overview of an optimization session.

FIG. 3 is a flowchart of the process of initialization with safe limits.

FIG. 4 is a flowchart of the process of previewing an optimization of thermal forming durations on a single section.

FIG. 5 is a flow chart of the process of previewing an optimization whose goal is to speed up the entire machine.

FIG. 6 is a flow chart of the process of incrementally applying an optimized schedule using augmented constraints.

FIG. 7 is a geometric interpretation of the process of incrementally applying an optimized schedule using augmented constraints.

FIG. 8 is a flow chart of the process of incrementally applying an optimized schedule using interpolation.

FIG. 9 is a geometric interpretation of incrementally applying an optimized schedule using interpolation.

### BRIEF DESCRIPTION OF THE PREFERRED EMBODIMENT

An I.S. machine includes a plurality (usually 6, 8, 10, or 12) of sections 10. Each section has a blank station including a mold opening and closing mechanism 12 having opposed mold supports 14 which carry blank mold halves. When these mold supports are closed by a suitable displacement mechanism 16 which can displace the mold support between open (illustrated) and closed positions and which is displaced by a motor 18 such as a servo motor, discrete gobs of molten glass can be delivered to the closed blank mold. The open top of the blank mold will then be closed by the baffle of a baffle support 22, which is displaceable between remote and advanced positions by a force generating device such as a pneumatic cylinder or by a motor (such as a servo) 24. If the section is operating in the press and blow mode, the plunger of a plunger mechanism 26 is advanced vertically upwardly into the gob to form the parison. Cooling air will be supplied to the plunger via a valve V1. If the section is operating in the blow and blow mode, the finish is formed by applying settle blow air through a valve V2 in the baffle mechanism 22, and the parison is formed with the application of counterblow air to the plunger via a valve V3, while vacuum is applied to the baffle through a valve V4.

After the parison is formed, the baffle support is retracted, the mold supports are retracted and a pair of neck ring holder arms 30 which are rotatively supported by an invert mechanism, 31 will be rotated 180.degree by a servomotor drive 32. The blank station also includes a mold opening and closing mechanism 12 having opposed mold supports 14 which carry blow mold halves. These mold supports are displaced between open and closed positions by a suitable displacement mechanism 16, which is displaced force generating device such as a pneumatic cylinder or such as a motor (such as a servo) 18. With the parison located at the blow station, the mold supports are closed, the neck ring arms are opened to release the parison (each arm is displaceable by a pneumatic cylinder (not shown) which is operated with a suitable valve V5), the invert mechanism returns the neck ring arms to the blank side (the arms close prior to arrival) and a blow head support 34 which is displaceable between a retracted position and an advanced position where a supported blowhead closes the blow mold, is displaced to the advanced position by a suitable force generating device such as a pneumatic cylinder or such as a motor (such as a servo) 36 to blow the parison into the bottle. This final blow is controlled by a valve V6.

When the bottle is formed, the blowhead is retracted, blank molds are opened and a takeout mechanism 38 which is driven by a force generating device such as a pneumatic cylinder or such as a motor (such as a servo) 39, is displaced to pick up the formed bottle and carry it to a location above a deadplate 40 where it is cooled while suspended and then deposited onto the deadplate. In addition to the movement of mechanisms and devices, process air to mechanisms, moveable or stationary, may also be controlled. When the blow molds are closed, mold cooling air is turned on to cool the formed bottle.

Each section is controlled by a computer 42 which operates under the control of a 360 degree timing drum (programmable sequencer) which defines a finite number of angular increments around the drum at which mechanisms, etc., can be turned on and off each 360 degree rotation. The control knows the time it takes for rotating 360 degrees and this time can be fixed or defined as the duration between once per cycle pulses such as pulses originating from the feeder of the I.S. machine. Each valve is cycled (turned on and off) and each mechanism is cycled within the time of one machine cycle by an electronic timing drum (programmable sequencer) which is part of the computer 42.

The invention described here provides an interactive software tool that helps the user produce a schedule with a minimal cycle period, and/or a schedule, which obtains thermal forming durations as close as possible to the user's desired values. It is applicable to non-servo IS Machines. The automatically generated schedule will ensure that all events occur within user set sequence and collision margin limits. In the event that the desired forming durations are not achievable, within the defined constraints of mechanism speeds, and cycle duration, the best compromise will be achieved.

When the user wishes to change the speed of the machine, the system automatically provides optimized timings for all of the machine's sections. If the desired speed increase cannot be achieved for all sections, the system will provide a schedule and speed increase that is achievable by the slowest section.

In contrast to an all servo the motion profiles and durations of mechanisms are unknown for a traditional IS machine so that it is not possible to directly compute collision and sequence margins as a function of event timing. Instead, the new approach relies on visual observation and feedback from the user to assess the allowable limits on these quantities. To support this approach the new system provides the capability to apply the optimized settings incrementally to the machine as it is running. This allows the user to observe the operating machine and assess the remaining collision and sequence margins as well as the effect of changing thermal forming durations on the ware quality.

With the schedule generation capability provided by the invention described here, these desired process adjustments could be made automatically without exceeding user set limits on sequence margin, collision margin or other or other constraints. Such adjustments could of course be made in an iterative fashion to continuously adjust the process for optimal production rate and quality.

The underlying basis of the schedule automation methodology is a mathematical model that provides a precise and complete description of the activities required to accomplish the particular glass forming process (e.g. blow and blow) and the constraints, which must be satisfied by a valid schedule. The network modeling approach (Ref 1) is used and extended in this application preserved for the ISCO (IS Cycle Optimizer), non-servo machine application.

The only changes to the modeling approach needed for the are 1) The granularity with which the mechanism motions are represented and 2) the interpretation of the associated sequence and collision constraints.

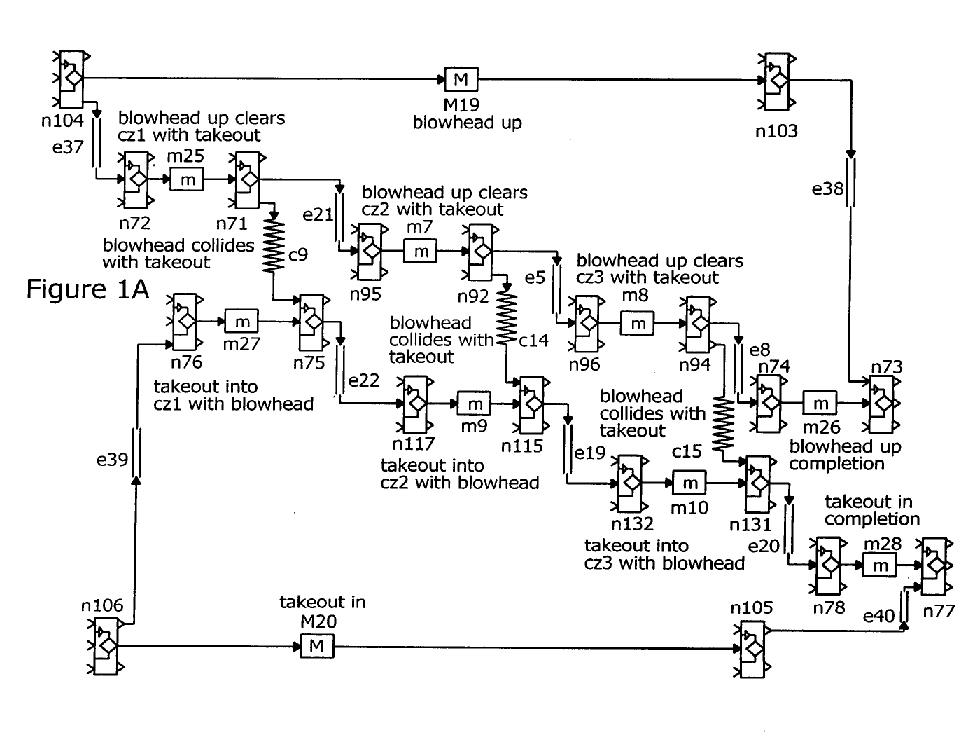

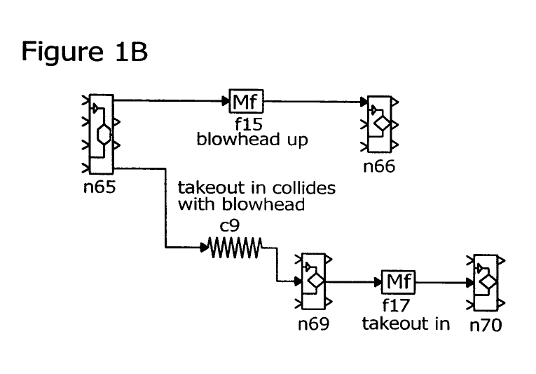

Because there is no detailed knowledge of the motion profile, the ISCO does not utilize submotion branches to break an overall motion into separate phases. Pairs of mechanisms that can collide are identified by simply connecting a collision branch between the start or end nodes of the two motion branches. This is illustrated in FIG. 1, which compares the representation of the Blow Head Up/Takeout-In collision pair for a NIS and an IS machine.

In the NIS approach where submotions are modeled, a negative duration for a collision branch, or sequence branch implies that the mechanisms will collide, or events will be out of order. Without the submotions, this is no longer the case. Instead, we can only look at changes in these durations from their original values, and infer that if they get smaller (close to negative infinity) then the mechanisms will be closer to colliding (or being out of sequence).

For an example of a situation where negative collision branch durations will commonly occur, consider the case of the takeout-out and invert motions. If the start of takeout-out is sufficiently delayed while the start of invert remains constant, the parison will collide with the outgoing ware. We would then model this situation with a collision branch drawn from the Start of Takeout-Out to the Start of Invert. Due to the relative speeds and travel distances of these two mechanisms, we will typically find that the Start of Takeout-Out actually occurs after the Start of Invert. Thus the collision branch duration would nominally be negative when the mechanisms are operating normally without collision.

When creating, and analyzing the Network Constraint Diagram, It is sometimes more natural, particularly with sequence branches, to have connections to the end nodes of motion branches. For example Start of Final Blow occurs after the End of Blowhead Down. With this approach, we must supply arbitrary fictitious values for the motion durations. As a result the duration of sequence branches, which represent start to end or end to start constraints, may nominally be negative under normal operation. We can, however, always infer that as these values become smaller, the events will be getting closer to being out of order, or further out of order.

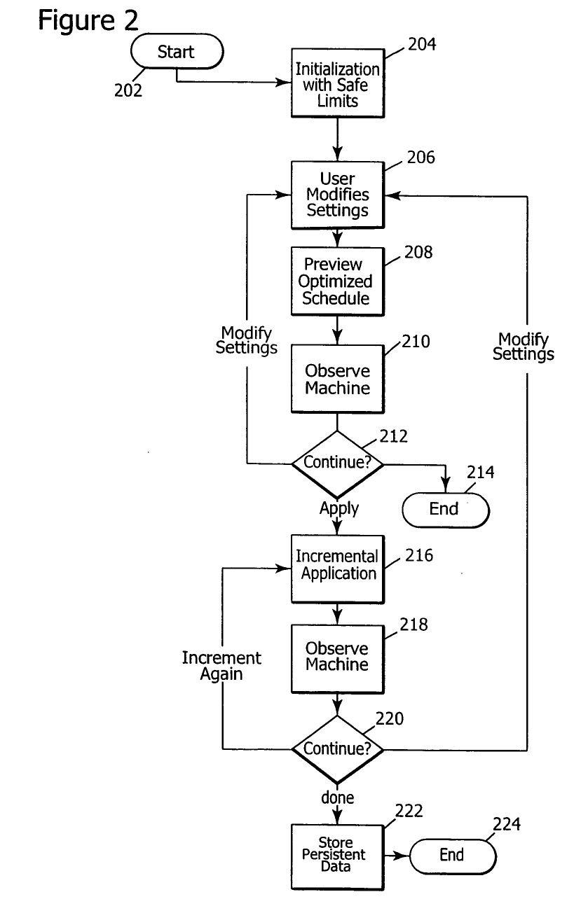

A flowchart providing a high level overview of an optimization session is shown in FIG. 2. The session is initiated at 202. Limits are initialized by 204 such that the collision and sequence margins will not be any worse than they are with the current job timing. The user then modifies, as required, the current target and limit values for the network branches through the user interface 206. Using these settings, an optimization is performed and a preview of the optimal solution is provided to the user by 208. This preview includes the optimized duration of the network branches, as well as an indication of the active limits and how they should be adjusted to allow the optimal solution to be closer to the target values. The user then observes the operation of the machine 210 and assesses whether the suggested adjustments to the active limits are acceptable. (e.g. is a particular pair of mechanisms truly on the verge of colliding or is there remaining margin?) Based upon the previewed results, and users observations, the user can elect through decision block 212 to make further modifications to the optimization settings by returning to 206, discontinue the session and not change the event timings 214, or to continue and apply the changes. If the user continues, the timing of the machine will be moved incrementally from its current state to the optimized timing by 216. Each execution of 216 changes the event angles by at most, some prespecified maximum increment. After each such incremental change, the user observes the operation of the machine 218 to verify that there are no imminent collisions, sequencing problems or undesirable affects to the ware formation. Based upon this observation, the user can elect through decision block 220 to make the next incremental change by returning to 216, make further modifications to the optimization settings 206, or discontinue the optimization process. If the user discontinues the optimization process, the settings (persistent data) are stored at the user's option by 222 and the session is ended 224.

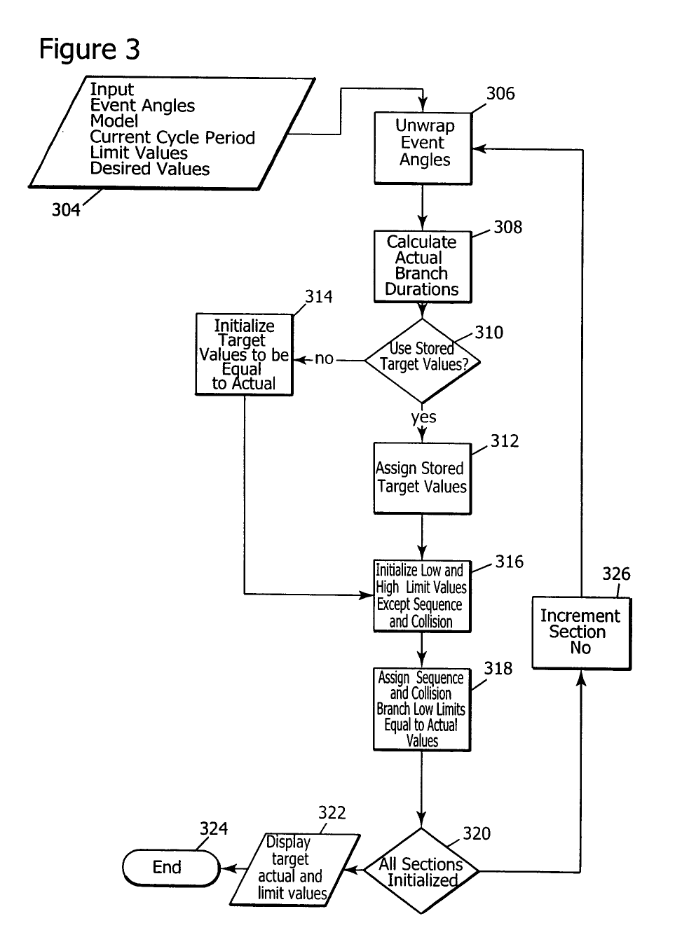

The process of initially setting safe limits and other initialization 204 is further detailed in the flowchart shown in FIG. 3. The process is initiated with input 304 of the Event Angles, Model Data, Current Cycle Period, Limit Values and Desired Values. A loop is then entered to initialize each machine section. The loop begins with 306 unwrapping the 0-360 degree event angle schedule for the current section to produce a set of unwrapped event times. Using the unwrapped event times, the branch durations for all of the Network Constraint Diagram (model) branches are calculated by 308. A choice is made by decision block 310 whether or not to use stored target values. If the decision is to use previously stored values (e.g. ones that were stored at an earlier time when it was known that the ware quality was good) then the targets are set to the stored values by 312. Otherwise, for example the first time the optimizer is run with a new model, the targets are initialized to be equal to their actual (current) values by 314. Next 316 initializes all of the low and high limit values using default values for all branches except the sequence and collision branches. The sequence and collision branches are set to equal their actual values by 318. Assuming that the machine is currently operating properly these actual values provide safe, although possibly overly conservative low limits. Decision block 320 tests whether all sections have been initialized. If not, the section number is incremented by 326 and the loop is repeated. Otherwise the actual branch durations, targets and limits are displayed by 322 for the user to view and the initialization process is completed 324.

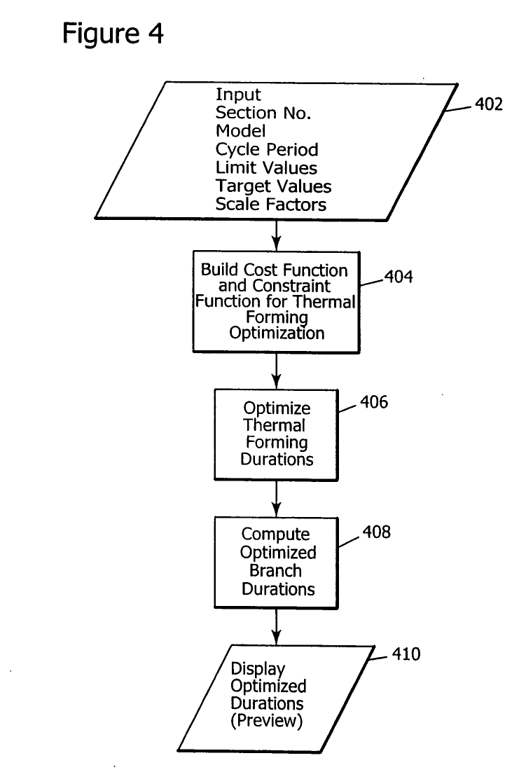

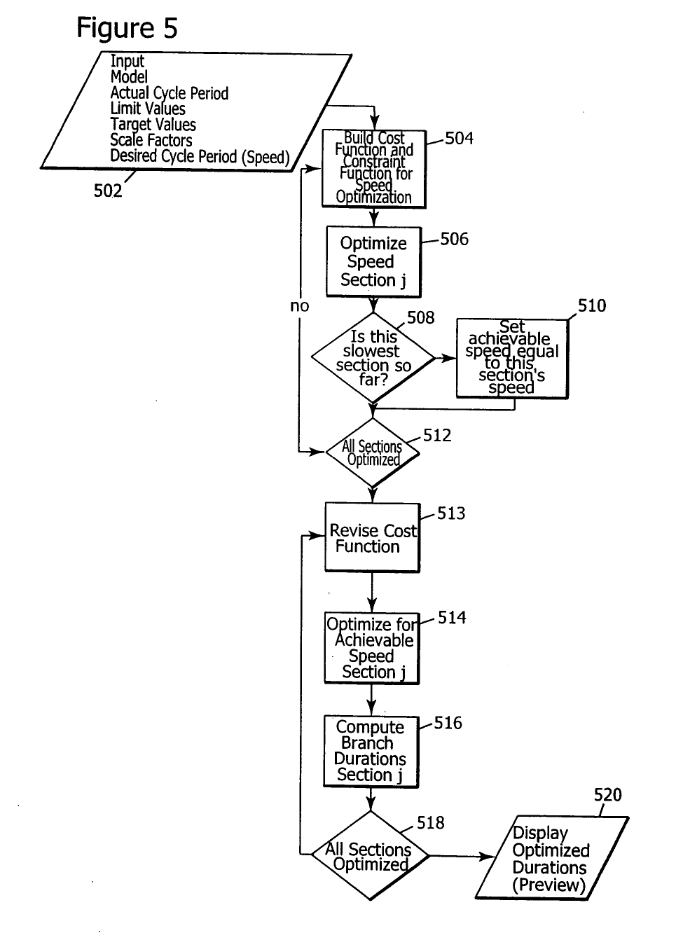

Two variants of the process of previewing an optimized schedule 208 are detailed in FIG. 4 and FIG. 5. The process of previewing an optimization of thermal forming durations on a single section is flowcharted in FIG. 4. Previewing an optimization whose goal is to speed up the entire machine is shown in FIG. 5.

The process of optimizing and previewing thermal forming durations on a single section will be described with reference to the flowchart shown in FIG. 4.

The optimization process is initiated 402 using the inputs: Section Number to be optimized, model data, current cycle period, target values, limit values and scale factors. Using these values a cost function and constraint function are derived and built by 404. Using this cost function and constraint function a constrained optimization is performed by 406 producing an optimized schedule (set of unwrapped event times) which will approximate the desired thermal forming durations as closely as possible. The optimized branch durations are computed from the optimized schedule by 408 and displayed to provide a preview to the user by 410.

In general the event angles on all sections must be modified when optimizing the machine speed. This is because all sections must operate at the same speed and the optimal event timing for each section depends upon the machine speed. Taking this into account, the process of optimizing the machine speed will be described with reference to the flowchart shown in FIG. 5.

It can be seen in FIG. 5 that he overall speed change process consists of two main loops. The first loop determines the maximum achievable speed of the machine, which is limited, by the maximum achievable speed of the slowest section. The second loop optimizes all of the sections to run at the maximum achievable speed determined in the first loop. It is noted that this two-stage process ensures that all sections will run at the same speed as set by the most limiting section.

The process begins with input 502 of the model to be used, current cycle period, low and high limit values, target values, scale factors and desired cycle period. The first loop is then entered. This loop repeats over all of the machine sections. A cost function and constraint function for speed change is built by 504. The maximum (optimized) speed for the section is determined by the performing an optimization 506 using the cost function and constraint function computed by 504. A check is made by decision block 508 to determine if this is the slowest section so far. If so, the maximum speed value for this section is saved by 510 as the maximum achievable speed for the entire machine. Otherwise decision block 512 loops through the remaining sections or continues to the second loop. Once in the second loop, the cost function for the current section is revised by 514 using the achievable speed determined by 510. The system is then reoptimized for this achievable speed by 516, which produces an optimal unwrapped schedule of event times for the section. The corresponding branch durations are computed from the optimized event times by 518. Decision block 520 repeats the loop or continues on to 522 to display the optimized durations and speed for all of the sections.

Once the optimized schedule is determined, it is desirable to apply it to the operating machine without disrupting the glass making process. To accomplish this the machine timing is modified in small increments from its current operation to the final optimized value in a process that will be referred to as incremental application.

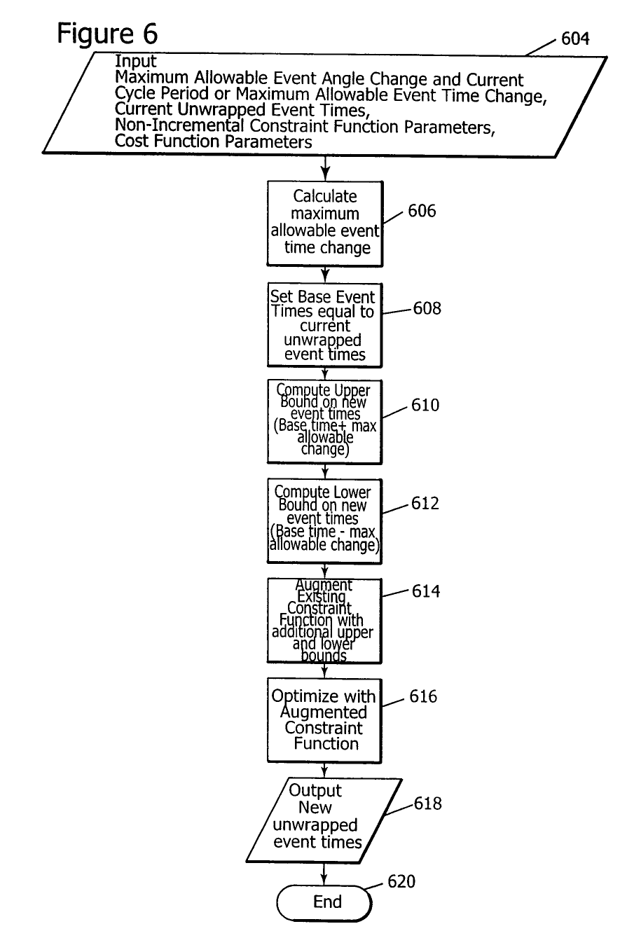

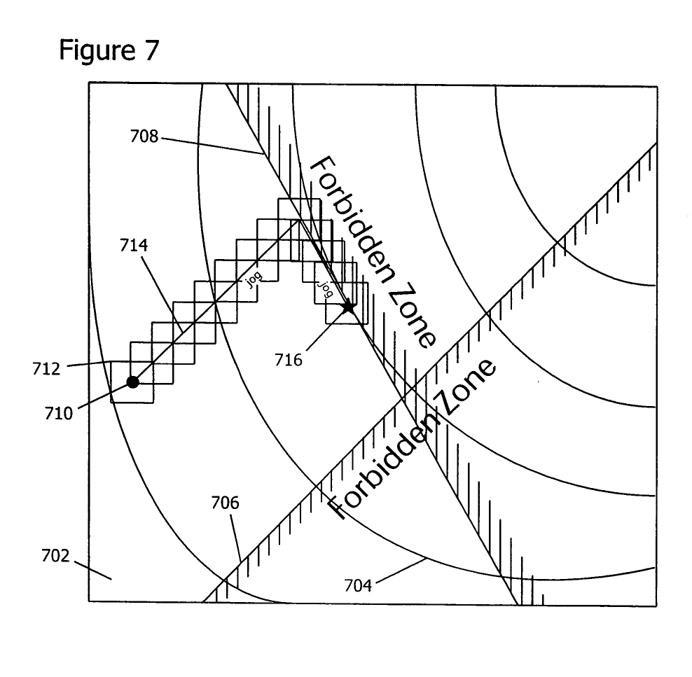

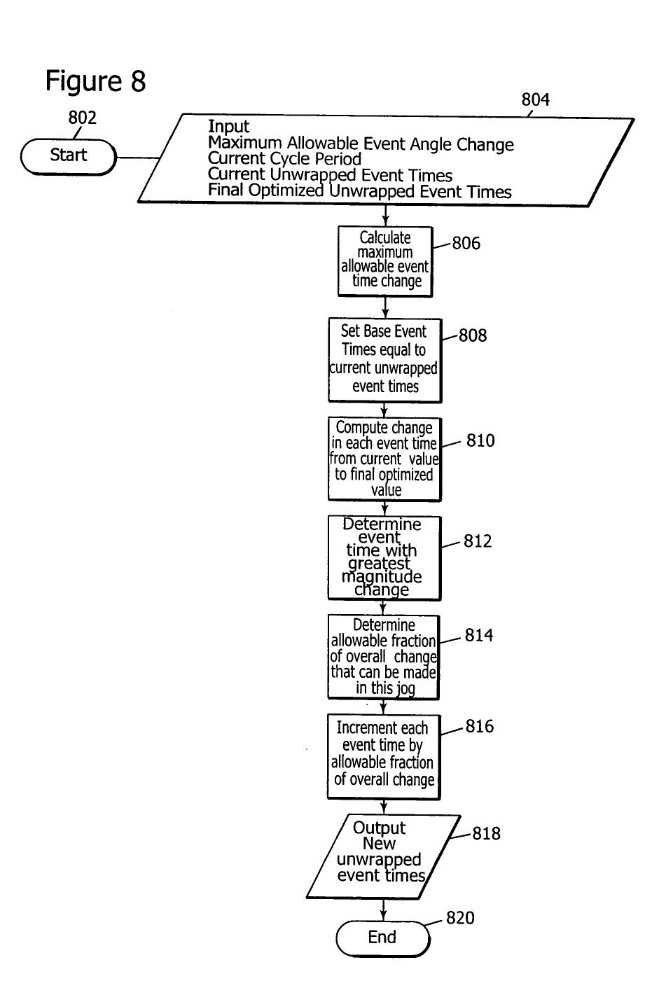

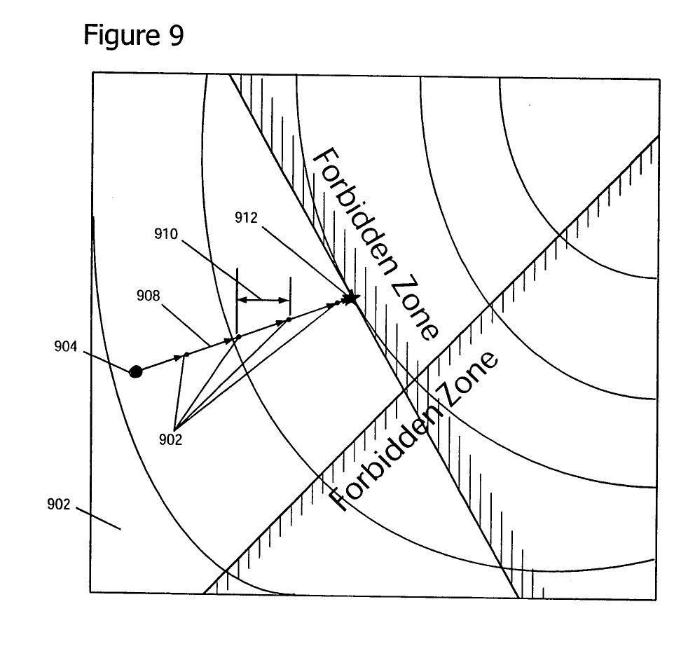

Two variants of the process of incrementally applying an optimized schedule, originally depicted by the block 216 in the high level view of FIG. 2, are detailed in FIG. 6 through FIG. 9. The use of augmented constraints is flowcharted in FIG. 6 and a geometric interpretation of this approach is provided in FIG. 7. An alternative approach, based upon interpolation, is flowcharted in FIG. 8, and a geometric interpretation of this approach is shown in FIG. 9.

Incremental Application Using Augmented Constraints is one approach to create intermediate schedules of events and their associated cycle times. This is detailed in the flowchart FIG. 6. This process is the augmented constraint approach; we repeatedly solve a constrained optimization problem with an augmented version of the original constraint function. Specifically, the constraint function of the original (preview) optimization is augmented with additional constraints that limit the maximum amount that each unwrapped event time can change from its current value. The process begins with input 604 of the maximum allowable event angle change, the current cycle period, and current unwrapped event times, the parameters of the original constraint function, and cost functions. Alternatively the maximum allowable event time change can be input, in which case the current cycle period is not needed. If the maximum allowable event time change is not input, it is calculated from the input maximum allowable event angle change and the current cycle period by 606. The base event times are defined to be equal to the current event times by 608. An upper bound on new event times is set by 610 by adding the maximum allowable event time to the base time. Similarly, the lower bound is computed by 612 by subtracting the maximum allowable change from the base times. The existing constraint function is augmented with these upper and lower bounds on admissible event times by 614. A constrained optimization using the original cost function and augmented constraint function is performed by 616. The resulting new unwrapped event times are then output by 618 and the process completes at 620 awaiting another request by the user to further increment toward the final optimized schedule.

This approach can be further understood by considering a geometric interpretation. In general, a schedule consisting of N event unwrapped event times can be considered as a single point in an N dimensional space. This is illustrated in FIG. 7 for a schedule that has only two event times. Any particular schedule is plotted as a point in the two dimensional plane 702 whose horizontal coordinate represents the event time for one event in the schedule, and vertical coordinate represents the second event in the schedule. On this plane we show level lines 704 of the cost function and constraint boundaries 706 and 708 for the original problem. The incremental application process begins at some starting schedule 710, which becomes the base time for the first application. The additional augmented constraints on the maximum allowable change can be visualized as the box 712 surrounding the base point 710. This augmented, constrained optimization problem is solved yielding the next schedule 718, which is at one of the augmented constraint boundaries. This becomes the new base point and the process is repeated following a path 714 until the final schedule 716 is reached.

Incremental Application Using Interpolation

In the interpolation approach, we find new schedules by interpolating between the initial and final (preview) schedules. This process is detailed in the flowchart shown in FIG. 6. The process begins with input 804 of the maximum allowable event angle change, the current cycle period, current unwrapped event times and final optimized unwrapped event times. Alternatively the maximum allowable event time change can be input. In this case, the current cycle period is not needed. If the maximum allowable event time change is not input, it is calculated from the input maximum allowable event angle change and the current cycle period by 806. The base event times are defined to be equal to the current event times by 808. The change in each individual event time from its current value to its final optimized value is computed by 810. The event time with greatest magnitude change is determined by 812. The fraction of the overall change which can be made without changing this most sensitive event time by more than the allowable limit is calculated by 814. A new schedule is then calculated by 816 by incrementing the individual base event times by the product of the allowable fraction computed by 814 and the overall change in the individual event time computed by 810. The resulting unwrapped event angle schedule is output by 818 and the process is process completes at 820 awaiting another request by the user to further increment toward the final optimized schedule.

This approach can be further understood by considering the geometric interpretation illustrated in FIG. 9 for a simple two-dimensional (schedule with two event times) case. As discussed previously in reference to FIG. 7, any particular schedule can then plotted as a point in a two dimensional plane 902. New schedule points 906 are interpolated along the line 908 connecting the initial schedule 904 and the target schedule 912. Schedule points are spaced along the line so as not to exceed the maximum allowable per step change in any event time 910. In this example, this would be dictated by the change in the horizontal coordinate because a given movement along the line 908 will produce a greater change in the horizontal than in the vertical coordinate.

What is claimed is:

1. A control for a glass forming machine which includes a blank station for forming a parison from a gob of molten glass having a number of mechanisms, a blow station for forming a parison into a bottle, having a number of mechanisms, a feeder system including a shear mechanism for delivering a gob to the blank station, a mechanism for transferring a parison from the blank station to the blow station and a takeout mechanism for removing a bottle from the blank station,
wherein the machine has a set cycle time,
wherein each of the mechanisms is cycled within the time of one machine cycle,
wherein interferences exist between the motion paths of the gob, the parison,
wherein at least one of the mechanisms position is not determinable,
the bottle and individual mechanisms,
wherein the thermal forming of the parison and bottle involve a number of thermal forming processes occurring during the time of one machine cycle and having finite durations,
wherein process air is supplied for at least one process for a finite duration by turning a supply valve “on” and then “off” during the time of one machine cycle,
wherein the start of displacement of the mechanisms and the turning of the valves “on” and then “off” are events which are started according to a selected schedule at defined event times within a 360 degree machine cycle.
wherein an unwrapped bottle forming process wherein a gob of molten glass is sheared from a runner of molten glass, the gob is then formed into a parison in the blank station, the parison is then formed into a bottle in the blow station, and the bottle is then removed from the blow station, takes more than the time of one machine cycle to complete, comprising
a computer analysis means
for analyzing the computerized model having at least one constraint as a constrained optimization problem for determining, for at least one section, with target limits on at least one event a target optimized schedule of events to occur within a corresponding target cycle time and
for determining limits used to determine of the target schedule of events and
for determining, for at least one section, a plurality of sequential intermediate schedules of events to occur during a corresponding plurality of cycle times each intermediate schedule constrained by an incremental limit on the maximum change of any event in the schedule of events beginning with the initial schedule of events and corresponding cycle time and ending with the target schedule of events and corresponding target cycle time, and
an interface means
for displaying target schedules of events and intermediate schedules of events results,
for adjusting limits
for directing the application of a selected schedule
a data Interface means
for applying a selected schedules or target schedule to the machine

2. A control according to claim 1 wherein the interface means is a CRT display.

3. A control according to claim 1 wherein the data interface mean is and electronic interface to apply the selected schedule to the machine

4. A control according to claim 1 wherein the computer analysis means further comprises a initializing computing means for computing initialization parameters.
